(19) United States
(12) Patent Application Publication
(10) Pub. No.: US 2012/0211214 A1
(43) Pub. Date: Aug. 23, 2012

(54) Heatsink Device and Method

(75) Inventor: Hien Van Phan, Cypress, CA (US)

(73) Assignee: Panasonic Avionics Corporation

(21) Appl. No.: 13/316,403

(22) Filed: Dec. 9, 2011

Related U.S. Application Data
(60) Provisional application No. 61/421,564, filed on Dec. 9, 2010.

(51) Int. Cl. F28F 7/00; B23P 15/26

(52) U.S. Cl. 165/185; 29/890.03

(57) ABSTRACT

A heatsink device and methods for manufacturing and using same. The heatsink device includes a plurality of heatsink fins that extend from a heatsink base. Each heatsink fin has a distal end region and a proximal end region disposed adjacent to the heatsink base. A fin width of each heatsink fin progressively decreases from the proximal end region to the distal end region in accordance with a parabolic profile such that opposing fin profiles of adjacent heatsink fins define an air space that is parabolic. The parabolic chamfer advantageously promotes full heat flow from the heatsink base to the heatsink fins and removes more heat than conventional heatsink devices. When applied in conjunction with a heat-generating component, the heatsink can enable the heat-generating component to operate at a lower stabilized component temperature. Accordingly, the performance, reliability, safety, and operational lifetime of the heat-generating component can be increased.

### CROSS-REFERENCE TO RELATED APPLICATIONS

This application claims priority to U.S. provisional patent application Ser. No. 61/421,564, filed Dec. 9, 2010. Priority to the provisional patent application is expressly claimed, and the disclosure of the provisional application is hereby incorporated herein by reference in its entirety for all purposes.

### FIELD

The disclosed embodiments relate generally to heatsink devices for providing heat dissipation and more particularly, but not exclusively, to static heatsink devices for applications, wherein heat transfer and dissipation need to be maximized to improve application functionality, reliability, and mean time between failures (MTBF).

### BACKGROUND

Overheating is a frequent cause of electrical and mechanical failures. One or more system components within an electronic and/or mechanical system can stop functioning if a system temperature of the system components exceed a predetermined thermal limit.

A heat sink is a term for a component or assembly that transfers heat generated within a solid material to a fluid medium, such as air or a liquid. Examples of heat sinks are the heat exchangers used in refrigeration and air conditioning systems and the radiator (also a heat exchanger) in a car. Heat sinks also help to cool electronic and optoelectronic devices, such as higher-power lasers and light emitting diodes (LEDs).

A heat sink is physically designed to increase the surface area in contact with the cooling fluid surrounding it, such as the air. Approach air velocity, choice of material, fin (or other protrusion) design and surface treatment are some of the design factors which influence the thermal resistance, i.e. thermal performance, of a heat sink. One engineering application of heat sinks is in the thermal management of electronics, often computer central processing unit (CPU) or graphics processors. For these, heat sink attachment methods and thermal interface materials also influence the eventual junction or die temperature of the processor(s). Thermal adhesive (also known as heatsink compound) is added to the base of the heatsink to help its thermal performance.

To understand the principle of a heat sink, consider Fourier's law of heat conduction. Joseph Fourier was a French mathematician who made important contributions to the analytical treatment of heat conduction. Fourier's law of heat conduction, simplified to a one-dimensional form in the x-direction, shows that when there is a temperature gradient in a body, heat will be transferred from the higher temperature region to the lower temperature region. The rate at which heat is transferred by conduction is proportional to the product of the temperature gradient and the cross-sectional area through which heat is transferred.

Using the mean air temperature is an assumption that is valid for relatively short heat sinks. When the air flow through the heat sink decreases, this results in an increase in the average air temperature. This in turn increases the heat sink base temperature. And additionally, the thermal resistance of the heat sink will also increase. The net result is a higher heat sink base temperature.

The inlet air temperature relates strongly with the heat sink base temperature. For example, if there is recirculation of air in a product, the inlet air temperature is not the ambient air temperature. The inlet air temperature of the heat sink is therefore higher, which also results in a higher heat sink base temperature.

Therefore, if there is no air or fluid flow around the heat sink, the energy dissipated to the air cannot be transferred to the ambient air. Therefore, the heat sink functions poorly.

Other examples of situations in which a heat sink has impaired efficiency:
Pin fins have a lot of surface area, but the pins are so close together that air has a hard time flowing through them;
Aligning a heat sink so that the fins are not in the direction of flow; and
Aligning the fins horizontally for a natural convection heat sink. Whilst a heat sink is stationary and there are no centrifugal forces and artificial gravity, air that is warmer than the ambient temperature always flows upward, given essentially-still-air surroundings; this is convective cooling.

To improve heat removal, a heatsink fan (or blower) assembly typically is installed adjacent to a conventional heatsink system to blow or otherwise force air across the fins of the heatsink system. One problem with this approach, however, is that the amount of air that the fan can force across the heatsink fins is limited due to a significant blockage of airflow pathways due to the fins themselves. Use of fans likewise presents drawbacks. For example, fans themselves make noise, consume electricity, and generate heat. Fans also can stop functioning or otherwise fail. The use of fans therefore generally is not recommended. Accordingly, conventional heatsink systems are limited and are not sufficient to remove heat as rapidly as necessary to ensure reliable operation of state of the art electronic and/or mechanical systems that have increased thermal cooling requirements.

As temperatures rise within the electronic and/or mechanical system, the conventional heatsink systems cannot transfer some heat from the system components, adversely effecting reliability and service life of the system components. Due to strict weight constraints within passenger vehicles, for example, overheating can pose be particularly problematic with vehicle information systems.

In view of the foregoing, a need exists for an improved heatsink device and method for transferring heat from a system component in an effort to overcome the aforementioned obstacles and deficiencies of conventional heatsink systems.

### BRIEF DESCRIPTION OF THE DRAWINGS

FIG. 1 illustrates a prior art heatsink device.

FIG. 2 is an exemplary detail drawing illustrating an embodiment of a heatsink device, wherein the heatsink device has adjacent heatsink fins with opposing sidewalls that form a parabolic chamfer (or profile).

FIG. 3 is an exemplary detail drawing illustrating an alternative embodiment of the heatsink device of FIG. 2, wherein the heatsink device includes one or more fractional (or partial) heatsink fins.

FIG. 4 is an exemplary detail drawing illustrating a comparison of an embodiment of the heatsink device of FIG. 2 with the prior art heatsink device of FIG. 1.

FIG. 5A is an exemplary detail drawing illustrating an exemplary top view of an embodiment of the heatsink device of FIG. 2, wherein the heatsink device includes a plurality of heatsink pin fins.

FIG. 5B is an exemplary detail drawing illustrating an exemplary side view of the heatsink device of FIG. 5A.

FIG. 5C is an exemplary detail drawing illustrating an exemplary front view of the heatsink device of FIG. 5A.

FIG. 6 is an exemplary detail drawing illustrating a manner by which the heatsink device of FIG. 2 can be coupled with a heat-generating component.

FIG. 7 is an exemplary detail drawing illustrating an alternative embodiment of the heatsink device of FIG. 2, wherein the heatsink device comprises at least two adjacent heatsink fins whose proximal end regions form a parabolic chamfer adjacent to the fin surface of the heatsink base.

FIG. 8 is an exemplary detail drawing illustrating an alternative embodiment of the heatsink device of FIG. 7, wherein the heatsink device includes one or more half-fins.

FIG. 9 is an exemplary detail drawing illustrating an embodiment of the heatsink device of FIG. 7, wherein the heatsink device is suitable for use with a vehicle information system.

FIG. 10 is an exemplary detail drawing illustrating an alternative embodiment of the heatsink device of FIG. 2, wherein the curvature includes a planar section.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

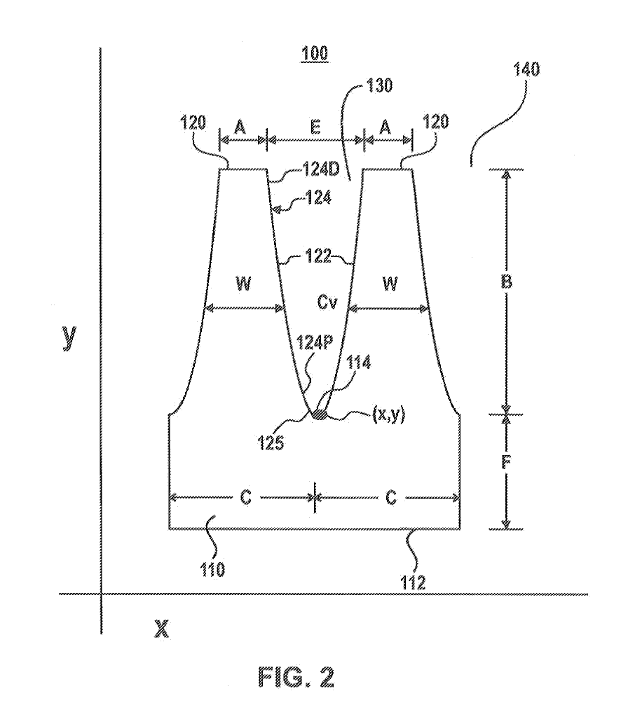

Since conventional heatsink systems cannot transfer sufficient heat that adversely affects reliability and service life of system elements, a heatsink device that provides better heat dissipation and enables the system elements to operate at higher ambient temperatures can prove desirable and provide a basis for a wide range of electrical, electromagnetic, and/or mechanical system applications that include heat-generating physical elements such as integrated circuits, resistors, and/or high-speed moving (or rotating) mechanical parts. This result can be achieved, according to one embodiment disclosed herein, by a heatsink device 100 as illustrated in FIG. 2.

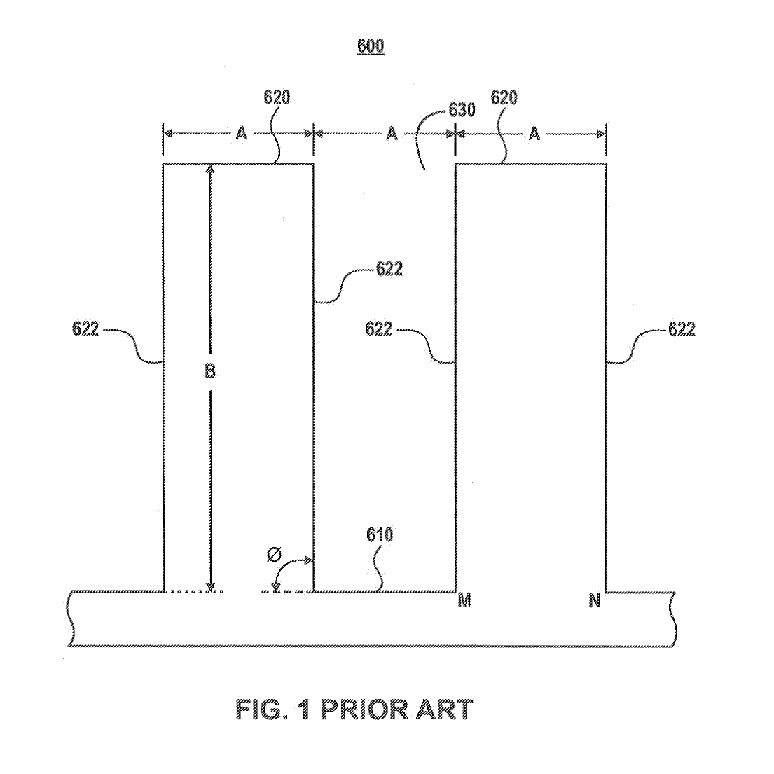

Turning to FIG. 1, a conventional (or prior art) heatsink device 600 is shown. The conventional heatsink device 600 is shown as comprising a plurality of heatsink fins 620 that extend from a heatsink base 610. As illustrated in FIG. 1, each heatsink fin 620 has a height B and a uniform fin width A such that the heatsink fin 620 forms a rectangle. Sidewalls 622 of the adjacent heatsink fins 620 are parallel and form an air space 630 between the adjacent heatsink fins 620. Stated differently, each sidewall 622 of the heatsink fins 620 forms a right angle φ with the heatsink base 610.

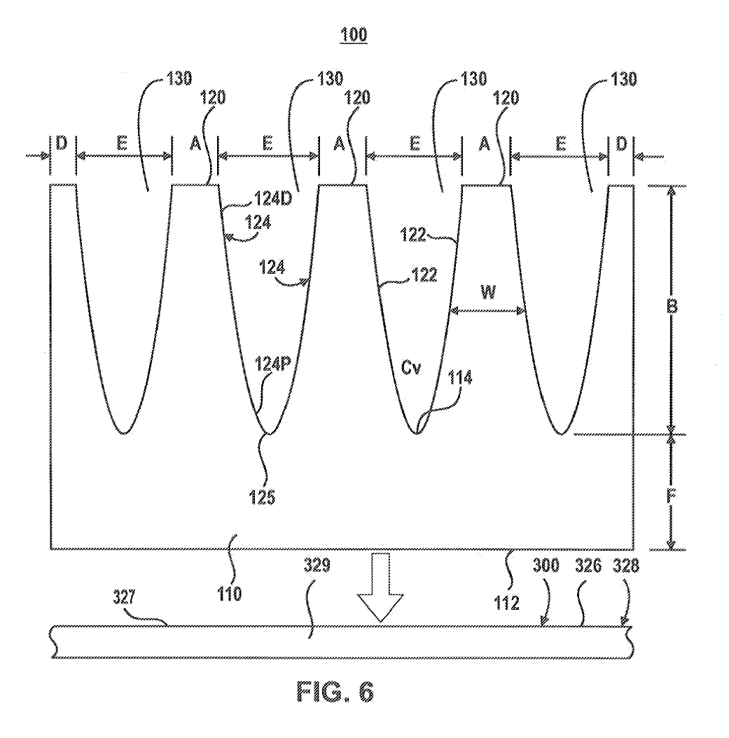

Turning to FIG. 2, a heatsink device 100 can be formed from any conventional heatsink material and is shown as including one or more heatsink fins 120 and a heatsink base 110 from which the heatsink fins 120 extend. The heatsink base 110 has a mounting surface 112 and a fin surface 114. The mounting surface 112 enables the heatsink base 110 of the heatsink device 100 to be disposed upon, or coupled with, a selected heat-generating component (and/or system) 329 (shown in FIG. 6) that might benefit from thermal regulation; whereas, the heatsink fins 120 are provided on the fin surface 114 of the heatsink base 110. Exemplary heat-generating components 329 can include electronic components, electromagnetic components, and/or mechanical components, without limitation, wherein functionality, safety, reliability, and/or mean time between failures (MTBF) of the heat-generating component 329 can be improved by increasing heat dissipation (and/or heat transfer). Although shown and described as being opposing surfaces of the heatsink base 110 for purposes of illustration only, the mounting surface 112 and the fin surface 114 each can be provided on any suitable surface of the heatsink base 110.

Extending from the fin surface 114 of the heatsink base 110, the heatsink fins 120 can be provided on the fin surface 114 in any conventional manner. For example, the heatsink fins 120 can be formed on, or coupled with, the fin surface 114. The heatsink fins 120 can extend from the fin surface 114 at any suitable angle. In one embodiment, for example, the heatsink fins 120 can extend perpendicularly from the fin surface 114. As shown in FIG. 2, each heatsink fin 120 includes opposite end regions 124: a proximal end region 124P; and a distal end region 124D. The proximal end region 124P is illustrated as being disposed adjacent to the heatsink base 110; whereas, the distal end region 124D is disposed a distance B from the heatsink base 110 and has a distal width A. In one preferred embodiment, the height B is equal to twice the height F of the heatsink base 110. The fin width W preferably progressively decreases from the proximal end region 124P to the distal end region 124D as illustrated in FIG. 2. The heatsink fins 120 can be provided with any suitable dimensions based, for example, upon a predetermined heatsink application. FIG. 2 shows that the spacing E between adjacent heatsink fins 120 as being equal to twice the distal width A of the heatsink fins 120. The ratio between the spacing E and the distal width A may be adjusted as desired according to applications in which the heatsink device 100 is used.

As shown in FIG. 2, a lengthwise cross-section 140 of the heatsink fin 120 has a shape that can satisfy a rounded or parabolic curvature Cv.

As shown in FIG. 2, adjacent heatsink fins 120 likewise can have opposing sidewalls 122 that form a parabolic chamfer (or profile) 125. In one illustrative embodiment, the curvature formed by the parabolic profile 125 itself, or the chamfer with the opposing sidewalls 122 between the adjacent heatsink fins 120, can satisfy the general parabolic formula:

y=k*x² (Equation 1)

wherein the origin of (x,y) coordinates is at the vertex (or midpoint) of the parabolic profile 125, and wherein y equals a preselected location along the height (B) of the heatsink fin 120 that is determined by a product of a coefficient k and a preselected offset x relative to the fin surface 114 from a midpoint of the parabolic profile 125. In other words, the opposing sidewalls 122 form a parabolic profile. The origin is located at the vertex of each parabolic profile 125, e.g. the vertex of the fin surface 114, opposite to the midpoint of the spacing E. The coefficient k optionally has a value within a range between 2 and 8, and optionally is within a 0.5 range of values between 2.5 and 5. Exemplary values of the coefficient k can include 2.5, 3.0, 3.5, 4.0, 4.5, and 5.0.
In accordance with Equation 1, then, for the embodiment of the heatsink device 100 shown in FIG. 2, the contour of each sidewall 122 can be defined as a function of the offset from the origin of the parabolic profile 125. The contour of each sidewall 122 from the heatsink base can be considered along the y-axis. The offset from the origin of the parabolic profile, located at the proximal region 124P on the fin surface, can be considered along the x-axis. Moving toward the distal end region 124D, the height of the sidewall 122 approaches height B. Similarly, along the x-axis, the distance between the distal end region 124D and the proximal end region 124P approaches one half of spacing E. Stated another way, the parabolic profile 125 shown in FIG. 2, can satisfy the parabolic formula:

y=(4B/E²)*x² (Equation 2)

wherein y=0 when x=0 and y=B when x=E/2.

In the manner discussed above, the sidewalls 122 of the adjacent heatsink fins 120 form the air space 130 between the adjacent heatsink fins 120 for promoting thermal regulation and heat transfer. As shown in FIG. 2, the air space 130 can be tangential to, and/or otherwise conform with, the contour of the parabolic profile 125 and the opposing sidewalls 122 of the adjacent heatsink fins 120.

The parabolic profiles 125 advantageously provide uniform heat flow from the heatsink base 110 to the heatsink fins 120. Stated differently, parabolic profiles 125 promote full heat flow from the heatsink base 110 to the heatsink fins 120 and thereby remove more heat than conventional heatsink devices 600 (shown in FIG. 1).

Having the proximal width C larger that is larger than the distal width A, the cross-sectional shape of the heatsink fins 120 advantageously enables heat to flow at near-maximum rate from the heatsink fins 120. The air space 130 permits air to flow between the heatsink fins 120 to carry heat away from the heatsink fins 120. The air space 130 likewise can reduce the total weight of the heatsink device 100. As shown in FIG. 2, the air space 130 adjacent to the distal end regions 124D of the adjacent heatsink fins 120 is formed with an air space width E that can be greater than, less than, and/or equal to the distal width A. In other words, the air space width E can be reduced (and/or increased), as desired, to further improve heat transfer rate in accordance with an air flow rate through the air space 130 and/or a permissible weight of the heatsink device 100. As desired, a heatsink fan (or blower) assembly (not shown) can be employed to provide sufficient air flow through the air space 130.

The parabolic profiles 125 advantageously promote heat transfer from the heatsink base 110 to the heatsink fins 120 by allowing full heat flow from the heatsink base 110 to enter the heatsink fins 120 without abrupt obstacles of sharp angle corners. The curvature of parabolic profiles 125 facilitates air flow between the heatsink fins 120 in a manner superior to that permitted by conventional heatsink devices 600 (shown in FIG. 1) with heatsink fins 620 (shown in FIG. 6A) that are formed with acute corners. The heatsink device 100 thus dissipates heat more efficiently than conventional heatsink devices 600, with or without fans. Further, dust may collect within the air space 130 adjacent to the heatsink base 110, and the parabolic profiles 125 can help to clean any collected dust.

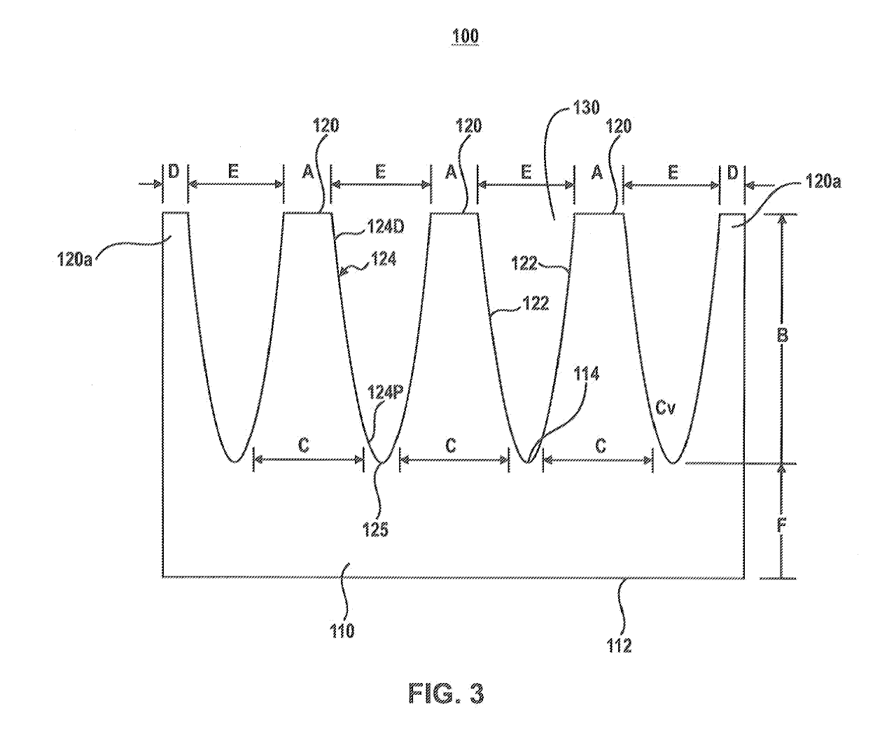

As desired, the heatsink device 100 can include one or more fractional (or partial) heatsink fins. A selected fractional heatsink fin can comprise any suitable fraction of a whole heatsink fin 120. For example, the fractional heatsink fin can have a width equal to a predetermined lengthwise fraction of the distal width of whole heatsink fin 120. The predetermined lengthwise fraction can be selected from a range between ten percent and ninety percent of the distal width and preferably is provided within a five percent range of fraction values. In the embodiment illustrated in FIG. 3, for example, the heatsink device 100 is shown as including two half heatsink fins 120a. More specifically, FIG. 3 shows, in one direction, an embodiment of the heatsink device 100 that includes three heatsink fins 120 disposed between two half-fins 120a. Each half-fin 120a has a distal width D that is equal to half the distal width A. The number of heatsink fins 120 can increase or decrease to accommodate a relevant dimension of a selected heat-generating component (and/or system) 329 (shown in FIG. 6). Further, the half-fin 120a at each end allows multiple heatsink devices 100 to located adjacent to each other when necessary and still allow the heatsink devices 100 to work together as a single large (or composite) heatsink device 100.

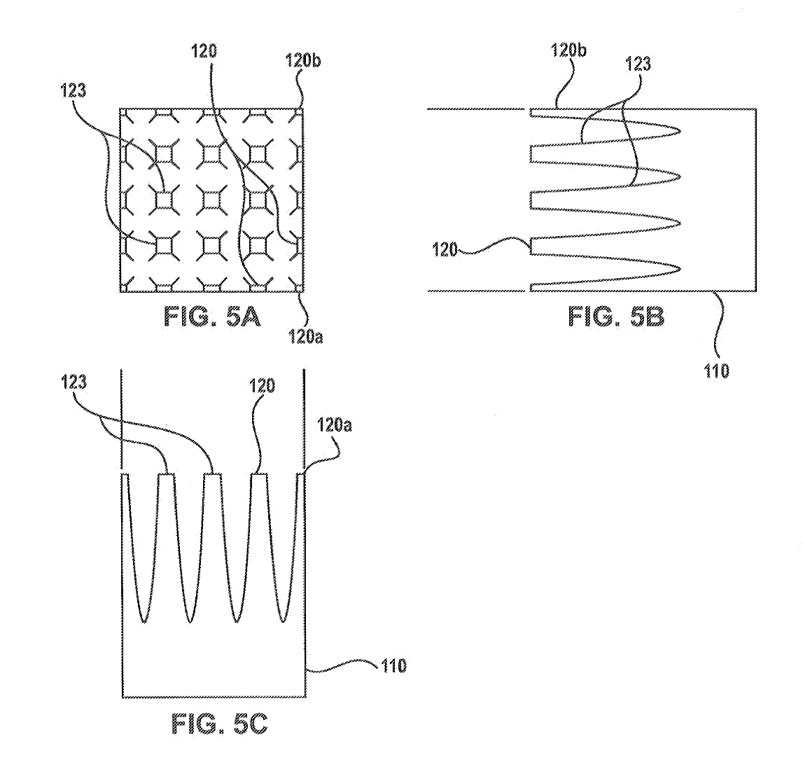

In one embodiment, the heatsink device 100 can have a heatsink profile that is formed (i.e., cut or molded) within conventional heatsink material in one or more other directions. For example, if the heatsink profile is formed in the heatsink material in one direction, the resultant heatsink device 100 can include heatsink fins 120 that are provided as straight fins. Alternatively, a heatsink device 100 can include heatsink fins 120 that are provided as pin fins 123 (shown in FIGS. 5A-C) when the heatsink profile is formed in the heatsink material in more than one direction. In one embodiment, the heatsink profile can be formed in the heatsink material in orthogonal directions. A number of (whole and/or fractional) heatsink fins 120 formed in a selected first direction may be smaller than a number of heatsink fins 120 formed in a selected second direction, depending, for example, on the air flow design.

Turning to FIGS. 5A-C, an exemplary heatsink device 100 is shown that has been formed by applying the heatsink profile illustrated in FIG. 2. The heatsink profile has been applied in two orthogonal directions. The heatsink device 100 thereby has heatsink fins 120 that are provided as pin fins 123.

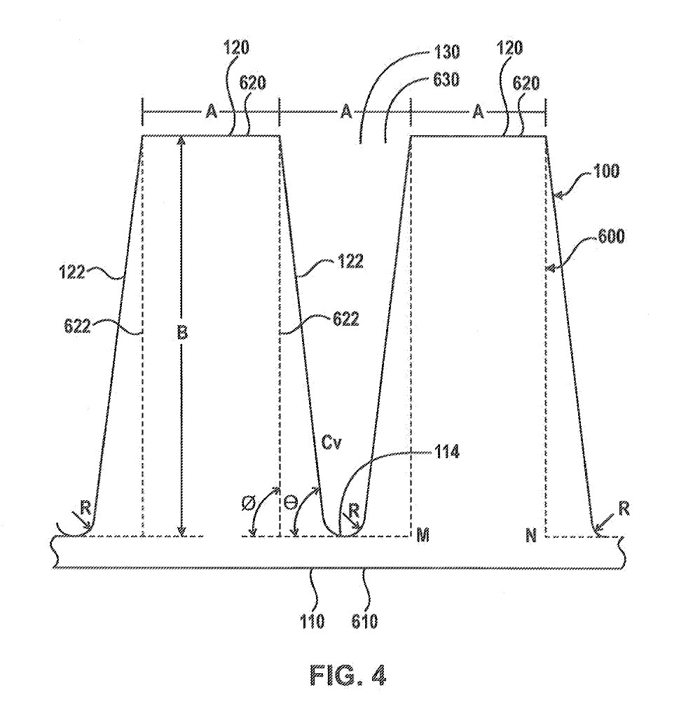

Turning to FIG. 4, the heatsink device 100 of FIG. 2 and the conventional heatsink device 600 of FIG. 1 are compared. As shown in FIG. 4, the sidewalls 122 of the heatsink fins 120 extend from the heatsink base 110 at an acute angle θ; whereas, the sidewalls 622 of the heatsink fins 620 extend from the heatsink base 610 at a right angle φ. The lengths of the sidewalls 122 of the heatsink fins 120 therefore are greater than the sidewalls 622 of the heatsink fins 620. Thereby, the heatsink fins 120 provide not only the fin volume but also a greater surface area than the heatsink fins 620 for supporting heat transfer. When used in conjunction with the selected heat-generating component (and/or system) 329 (shown in FIG. 6), the heatsink device 100 advantageously can enable the selected heat-generating component to operate at a higher thermal Upper Operating Limit than can the conventional heatsink device 600. The heatsink device 100 dissipates heat more efficiently than the conventional heatsink device 600 because heat in the heatsink device 100 flows from the heatsink base 110 to the heatsink fins 120 without being blocked by barrier MN. The parabolic chamfer 125 of the heatsink device 100 also enables an even heat flow rate throughout the heatsink device 100. The parabolic chamfer 125 of the heatsink device 100 provides for reduction in heat flow jam and dust build-up suffered by the conventional heatsink 600.

As shown in FIG. 6, the heatsink device 100 can be used in conjunction with the selected heat-generating component (and/or system) 329. When applied in conjunction with a selected heat-generating component 329, the heatsink device 100 can significantly improve heat dissipation (and/or heat transfer) for the selected heat-generating component 329. The heatsink device 100 thereby can enable the heat-generating component 329 to operate at a lower stabilized component temperature. Further, the heat-generating component 329 can operate more reliably than it would using less effective, conventional heatsinks 600 (shown in FIG. 1). In turn, the mean time between failures (MTBF) for the heat-generating component 329 is longer than it would be using less effective, conventional heatsinks 600. Accordingly, the performance, reliability, safety, and operational lifetime of the heat-generating component 329 can be increased, allowing cost savings in maintenance and insurance.

In operation, performance of the selected heat-generating component 329 can be adversely affected when the ambient temperature Ta is greater than a predetermined thermal Upper Operating Limit (UOL). The thermal Upper Operating Limit of the selected heat-generating component 329 typically is a function of ambient temperature and other device properties. When used in conjunction with the selected heat-generating component 329, the heatsink device 100 can help the selected heat-generating component 329 to operate at ambient temperatures Ta greater than the thermal Upper Operating Limit of the selected heat-generating component 329. The performance, reliability, and operational lifetime of the selected heat-generating component 329 thereby can be increased.

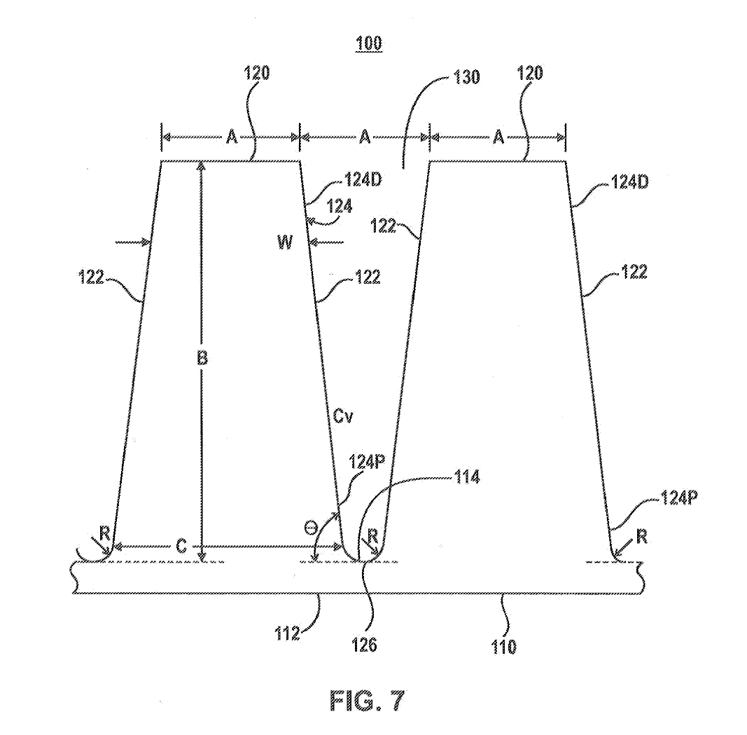

Although shown and described as having a parabolic profile 125 in FIGS. 2-6 for purposes of illustration only, the heatsink device 100 can have a profile 125 with any suitable geometry. Another embodiment of the heatsink device 100 is illustrated in FIG. 7. Turning to FIG. 7, the proximal end regions 124P of the adjacent heatsink fins 120 can alternatively form a parabolic chamfer 126 having a circular section with a radius R, adjacent to the fin surface 114 of the heatsink base 110. Further, FIG. 7 shows that the spacing between adjacent heatsink fins 120 can be equal to the distal width A of the heatsink fins 120. The ratio between the spacing and the distal width A may be adjusted as desired according to applications where the heatsink device 100 is used.

In the manner set forth above, the heatsink device 100 can be advantageously applied in a wide range of electrical and/or mechanical system applications that contains heat-generating physical elements like integrated circuits, capacitors, resistors, high-speed moving (or rotating) mechanical parts. Exemplary heatsink applications can include, but are not limited to, vehicle information (or entertainment) systems suitable for installation and/or use aboard passenger vehicles, laptop computer systems, computer systems, microcomputer systems, audio/video systems, medical electronic systems, avionics systems, automated systems, and any other systems (or appliances) that comprise one or more heat-generating components. The heatsink device 100 is suitable for use in systems wherein at least one system element is not permitted to reach (or exceed) the higher thermal Upper Operating Limit. By reducing system element temperatures, the heatsink device 100 can improve reliability and life time of the system elements even when high temperature is not a major issue.

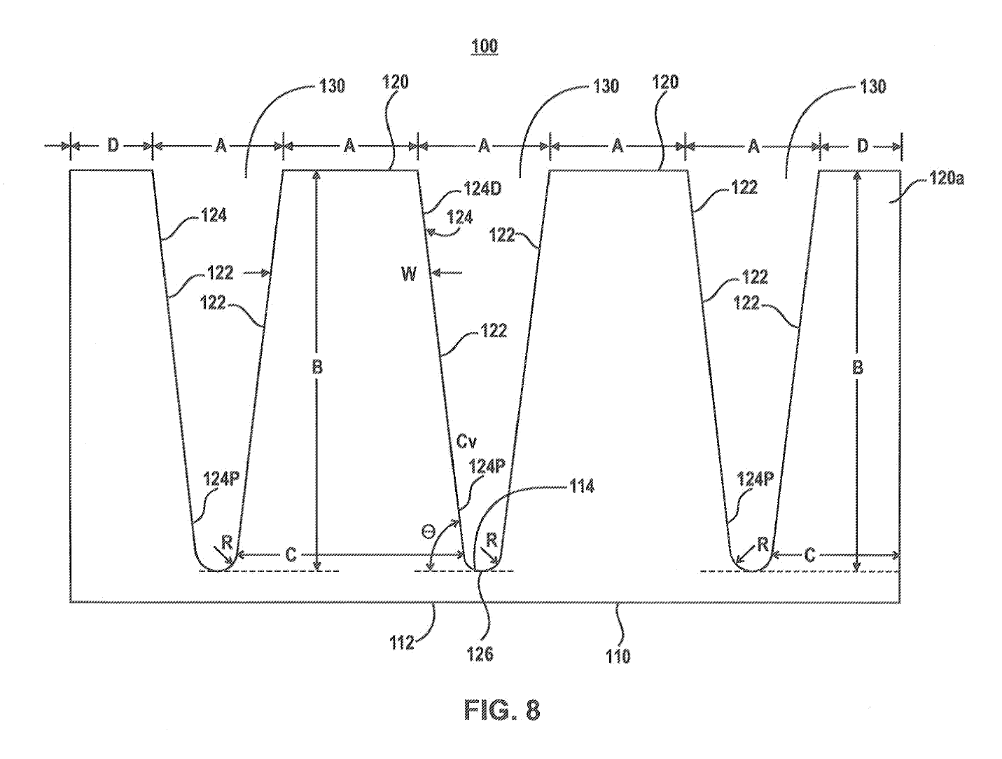

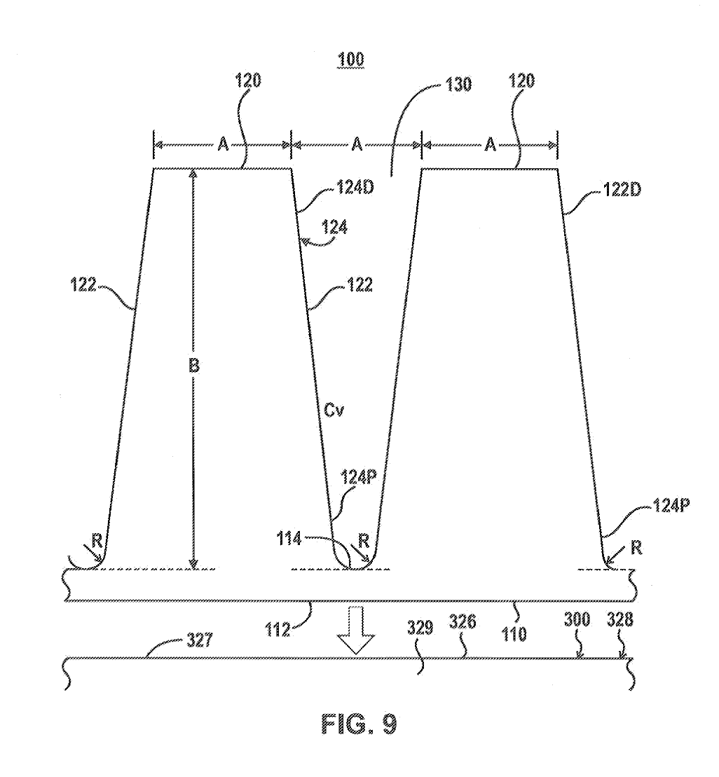

FIG. 8 shows, in one direction, an embodiment of the heatsink 100 of FIG. 7, wherein two heatsink fins 120 are disposed between two half-fins 120a, one at either end. Each half-fin 120a has a distal width D, equal to half the distal width A. However, the number of heatsink fins 120 can increase or decrease to fit the size of the selected heat-generating component (and/or system) 329 (shown in FIG. 9). Further, the half-fin 120a at each end allows multiple heatsink devices 100 to located adjacent to each other when necessary and still allow the devices to work together as a single large heatsink device.

FIG. 8 shows the profile of the heatsink device 100 from the front view (i.e., in one direction). In addition, a similar profile may be cut or molded from the conventional heatsink material in an orthogonal direction in the manner discussed in more detail above with reference to FIGS. 2 and 5A-C. Further, the number of heatsink fins 120 or fin surfaces (or chamfers) 114 in one direction may be smaller than that in the other direction, depending on the air flow design.

FIG. 9 illustrates the heatsink device 100 of FIG. 7 being used in conjunction with the selected heat-generating component (or system) 329. As shown in FIG. 9, the mounting surface 112 of the heatsink device 100 can be disposed on a suitable package (or housing) surface 327 of the selected heat-generating component 329 in a conventional manner. For example, the heatsink device 100 can be coupled with the housing surface 327 of the selected heat-generating component 329 via conventional heatsink compound to increase thermal communication between the selected heat-generating component 329 and the heatsink device 100.

As desired, the heatsink device 100 can be used in conjunction with an information system 328 (shown in FIGS. 6 and 9). For example, if the information system 328 comprises a vehicle information system 300 with at least one line replaceable unit (LRU) 326, the heatsink device 100 can be disposed upon the line replaceable unit 326. Line replaceable units 326, for example, can include any system resource of the information system 328 such as a switching system (not shown), an area distribution box (not shown), a floor disconnect box (not shown), a seat electronics box (and/or a video seat electronics box and/or a premium seat electronics box) (not shown), a transceiver system (not shown), a content source (not shown), a server system (not shown), a headend system (not shown), a video interface system, an audio interface system, or a user input system.

The line replaceable unit 326 may stop working properly if unit temperature is greater than a predetermined thermal Upper Operating Limit (UOL). The thermal Upper Operating Limit of the line replaceable unit 326 typically is a function of ambient temperature and other unit properties. The heatsink device 100 transfers heat from the line replaceable unit 326 better than conventional heatsink devices 600 (shown in FIG. 1). The heatsink device 100 thereby can help the line replaceable unit 326 to operate at temperatures greater than the thermal Upper Operating Limit. The performance, reliability, and operational lifetime of the line replaceable unit 326 thereby can be increased.

Exemplary line replaceable units 326 suitable for use with the information system 328 are set forth in U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES,” and in U.S. Pat. No. 7,675,849, entitled “SYSTEM AND METHOD FOR ROUTING COMMUNICATION SIGNALS VIA A DATA DISTRIBUTION NETWORK,” which are assigned to the assignee of the present application and the respective disclosures of which are hereby incorporated herein by reference in their entireties. Alternatively, and/or additionally, the distribution system 320 can be provided in the manner set forth in the co-pending U.S. patent application “OPTICAL COMMUNICATION SYSTEM AND METHOD FOR DISTRIBUTING CONTENT ABOARD A MOBILE PLATFORM DURING TRAVEL,” Ser. No. 12/367,406, filed Feb. 6, 2009, which is assigned to the assignee of the present application and the disclosure of which is hereby incorporated herein by reference in its entirety.

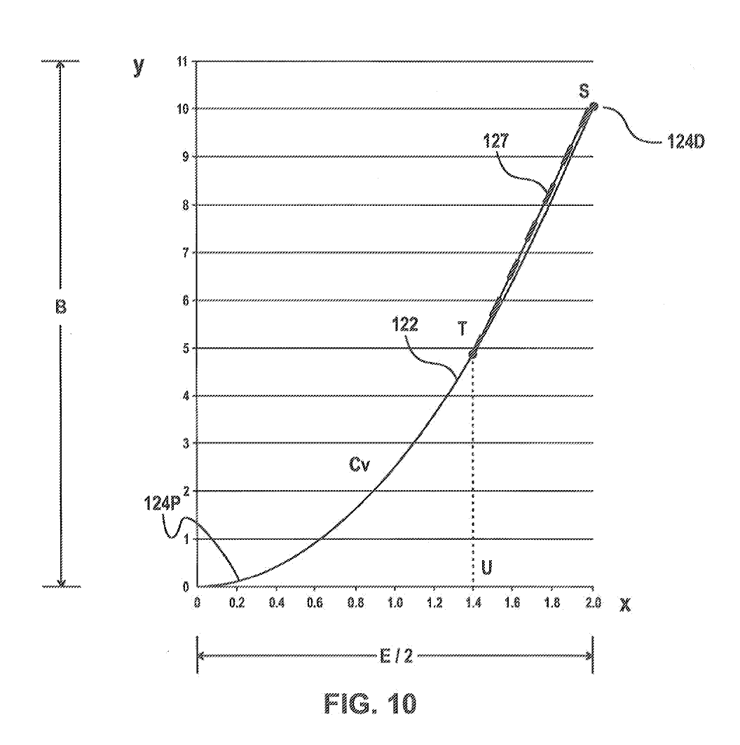

FIG. 10 is an exemplary detail drawing illustrating an alternative embodiment of the heatsink device 100 of FIG. 2, wherein the curvature Cv of the sidewall 122 includes a planar section 127. To facilitate implementation, an appropriate portion TS of the curvature Cv of the sidewall 122 (from 124P to 124D) can be made planar from a preselected point U to the distal end region 124D. The justification for design acceptance of the planar section 456 is that the profile of the planar section 127 is a close enough approximation to the curve ST from the preselected point U to the distal end region 124D without sacrificing thermal improvement properties achieved by the enhanced design of the heatsink 100.

Stated another way, the curvature Cv of the sidewall 122 shown in FIG. 10, can satisfy the parabolic formula:

y=2.5*x² (Equation 3)

wherein y=0 when x=0, and y=2.5*U² when x=U.

Further, the curvature Cv, from preselected point U to the distal end region 124D, includes planar section 127 having a profile that can satisfy the linear formula:

y=2.5*x (Equation 4)

wherein y=0 when x=0.

Table 1 below illustrates exemplary profile dimensions of an exemplary heatsink device according to selected embodiments.

TABLE 1

| | | Value (length | Value (length |
|---|---|---|---|
| Parameter | Relationship | units) for k = 2.5 | units) for k = 4.0 |
| A | B * p (p = 2 to 8) | 4 | 3.16 |
| B | See Parameter A | 2 | 1.58 |
| C | B/2 | 1 | 0.79 |
| D | E * 2 | 10 | 10 |
| E | See Parameter D | 5 | 5 |

Table 1 illustrates that for a given area of a bottom plane of a heatsink device, a larger k value can provide for a larger number of fins and grooves. Table 1 also illustrates that a cross section of the heatsink base 110 can be provided such that a near 1:1 balance in relation to the cross section 140 of heatsink fin 120 is achieved.

The heatsink device 100 can be provided with any conventional shape, size, and/or dimension. For example, the heatsink base 110 can have a cross-section that can be formed as a square, rectangle, circle, oval or any other suitable shape with any predetermined dimensions. The heatsink base 110, in one embodiment, can have a predetermined length and a predetermined width. The predetermined length can be up to three inches or more and, as desired, can be provided within any preselected half-inch range between one half inch and three inches. Likewise, the predetermined width can be provided in the manner set for above with reference to the predetermined length and can be equal to, or different from, the predetermined length. In one embodiment, the predetermined length and predetermined width of the heatsink base can be determined based on the selected heat-generating component for coupling with the heatsink device.

The heatsink device can be provided with fins of any shape without departing from the scope of the present disclosure. For example, heatsink fins can have a cylindrical, elliptical, triangular, rectangular, or square shape, while the curvature of the sidewalls can satisfy the above preferred design criteria.

The heatsink device can be provided with any conventional fin spacing configuration. For example, fins can be arranged in rows having a staggered relationship or a non-staggered relationship. Fins can be spaced according to optimizing surface area into a given volume within the above preferred design criteria.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A heatsink device, comprising:
a heatsink base;
a first heatsink fin extending from said heatsink base, said first heatsink fin having a first sidewall; and
a second heatsink fin extending from said heatsink base, said second heatsink base having a second sidewall opposing the first sidewall of the first heatsink fin, the first sidewall and second sidewall forming a parabolic curvature,
wherein the parabolic curvature enables heat to flow at near-maximum rate from said heatsink base.

2. The heatsink device of claim 1, wherein the parabolic curvature satisfies the parabolic formula y=k*x², where k is a preselected offset relative to a fin surface from a vertex (x,y) of said parabolic curvature, wherein the coefficient k has a value within a range between 2 and 8, and wherein the parabolic curvature is sufficiently asymptotic such that the parabolic curvature can be approximated by a planar portion.

3. The heatsink device of claim 1, wherein said first heatsink fin includes a fin width, said fin width progressively decreasing from a proximal width at a proximal end region of said first heatsink fin to a distal width at a distal end region of said heatsink fin.

4. The heatsink device of claim 1, wherein said first heatsink fin and said second heatsink fin are adjacent.

5. The heatsink device of claim 1, wherein a plurality of heatsink fins extend from said heatsink base, said heatsink fins each having a proximal end region disposed adjacent to said heatsink base and a distal end region having a distal width that is less than a width of said proximal end region.

6. The heatsink device of claim 5, wherein said plurality of heatsink fins are one or more of uniform and uniformly disposed on said heatsink base.

7. The heatsink device of claim 5, wherein a spacing between adjacent heatsink fins is equal to said distal width of said heatsink fins.

8. The heatsink device of claim 5, wherein said proximal end regions of adjacent heatsink fins form a parabolic profile that permits full heat flow from said heatsink base to enter said adjacent heatsink fins.

9. The heatsink device of claim 5, wherein said proximal end regions of adjacent heatsink fins form a circular chamfer that permit full heat flow from said heatsink base to enter said adjacent heatsink fins.

10. The heatsink device of claim 1, wherein said first heatsink fin is formed on said heatsink base.

11. The heatsink device of claim 1, wherein said first heatsink fin has a fin width that progressively decreases in accordance with the parabolic chamfer.

12. The heatsink device of claim 1, wherein said heatsink base is suitable for coupling with a heat-generating system elements selected from a system element group consisting of an integrated circuit, a capacitor, a resistor, a high-speed moving mechanical part, and a rotating mechanical part.

13. The heatsink device of claim 1, further comprising a heatsink fan that forces air across said heatsink fin.

14. The heatsink device of claim 1, wherein said first heatsink fin is provided as a whole heatsink fin, wherein said first heatsink fin is provided as a fractional heatsink fin comprising a predetermined lengthwise fraction of the whole heatsink fin, wherein the predetermined fraction is selected from a range between ten percent and ninety percent of the whole heatsink fin, wherein the predetermined fraction is within a five-percent range between ten percent and ninety percent of the whole heatsink fin, and wherein said fractional heatsink fin is provided as a half heatsink fin.

15. A method for manufacturing a heatsink device, comprising:
providing a heatsink base; and
disposing a heatsink fin on said heatsink base, said heatsink fin extending from said heatsink base and having a cross-sectional shape for providing a rounded profile,
wherein a curvature of the rounded profile of said heatsink fin enables heat to flow at near-maximum rate from said heatsink base.

16. The method of claim 15, wherein said disposing said heatsink fin on said heatsink base comprises disposing a plurality of heatsink fins on said heatsink base, said heatsink fins each having a proximal end region disposed adjacent to said heatsink base and a distal end region having a width that is less than a width of said proximal end region.

17. The method of claim 16, wherein the curvature of the rounded profile satisfies a parabolic formula y=k*x², where k is a preselected coefficient and the curvature has a vertex adjacent to said proximal end region of said heatsink fin.

18. A vehicle information system suitable for installation aboard a passenger vehicle, comprising:
a line replaceable unit associated with the vehicle information system; and
a heatsink device coupled with a suitable surface of said line replaceable unit and including:
a heatsink base;
a first heatsink fin extending from said heatsink base, said first heatsink fin having a first sidewall; and
a second heatsink fin extending from said heatsink base, said second heatsink base having a second sidewall opposing the first sidewall of the first heatsink fin, the first sidewall and second sidewall forming a parabolic curvature,
wherein the parabolic curvature enables heat to flow at near-maximum rate from said heatsink base.

19. The vehicle information system of claim 18, wherein said line replaceable unit is selected from a group consisting of a media server system, a content source, a switching system, an area distribution box, a floor disconnect box, a seat electronics box, a video seat electronics box, a monitor system, and a power supply system.

20. The vehicle information system of claim 18, wherein the passenger vehicle comprises an aircraft.
